(19) United States
(12) Patent Application Publication
(10) Pub. No.: US 2002/0183008 A1
(43) Pub. Date: Dec. 5, 2002

(54) Power door control and sensor module for a wireless system

(76) Inventors: Raymond J. Menard, Hastings, MN (US); Curtis E. Quady, Burnsville, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/867,276

(22) Filed: May 29, 2001

(51) Int. Cl. H04B 7/00

(52) U.S. Cl. 455/66; 455/41

(57) ABSTRACT

A module with a sensor to indicate the position of a door coupled to a door opener. The module is compatible with a wireless communication protocol and operates over both a long range, such as is used with a cellular telephone, and a short range, such as is used with BLUETOOTH®. A door position sensor coupled to the module provides information to the user over a wireless communication channel. In one embodiment, information from an additional door position sensor is wirelessly transmitted. In one embodiment, an audio transducer coupled to the module responds to voice commands to operate the door opener.

### TECHNICAL FIELD OF THE INVENTION

The present invention relates generally to the field of wireless control and monitoring and, in particular, to a wireless system for controlling and monitoring a power door.

### BACKGROUND OF THE INVENTION

For reasons of convenience and safety, many overhead garage doors are equipped with an electric door opener. Automobile drivers find it convenient to remotely open and close the overhead door without exiting their car. Homeowners also enjoy the convenience of opening the garage door with a push of a button. Often, a control button is wired directly to the opener and located on an interior surface of a garage wall. Homeowners also find that a properly installed electric garage door opener improves personal safety. Most doors are heavy and, unless operated with appropriate care, can be lethal if dropped on a child. Safety features of modem garage doors, including automatic reverse on obstruction and floor level optical sensors, provide some measure of protection against crushing a person.

However the typical garage door opener suffers from a number of problems. First, garage door openers lack any feedback to indicate the position of the door to the user. Unless the user observes complete closure of the door, there remains the possibility that the door will return to an open position after the user has driven out of view. For example, if a cat runs out of the garage moments before complete closure or if a broom handle falls in the path of the door, the opener will return the door to an open position. An unattended home with an open garage door is an easy target for a burglar. Second, in most cases, the user must use either the proprietary remote control encoded for use with the particular opener or the wired button usually affixed to a wall surface. If the remote control is unavailable, then the user is inconvenienced and forced to use other means to open the door. For example, without a remote control, the user may have to enter the garage using an alternate door or use an external switch. Third, typical garage door openers lack adequate security protection to prevent operation of the door by an unauthorized person. For example, in some cases, the wireless garage door opener access code can be stolen by a third party using code grabbing devices. Using such a device, a thief waiting near the home can copy the wireless access code and later return to burglarize the garage, and in some cases, the home.

A profile schematic of a residential garage door opener system 10 is illustrated in FIG. 1. In the figure, power unit 15 may include an electric motor that provides the force to open and close the garage door. Power unit 15 may include a belt drive, a chain drive, gear train or other power transmission means to convert rotational forces to linear motion. In the typical installation, power unit 15 is anchored securely to rafters or other ceiling structure in the garage by supporting structure 55, which may include angle iron or other stock.

Trolley mechanism 25 travels along track 20 in the directions shown generally by arrow 50. Track 20 is attached at one end to power unit 15 and attached at the other end to the garage structure at bracket 45. Actuator arm 30 is flexibly coupled to trolley 25 on one end and flexibly coupled to garage door 40 by bracket 35. Door 40 may be fabricated of wood, aluminum, steel, fiberglass or any other material and often includes multiple door panels, each of which is commonly referred to as a section, arranged in a hinged assembly. A section of door is illustrated in FIG. 1. The edge of each section of garage door 40 includes rollers. The rollers engage door tracks mounted along the sides of the door opening.

Switch 65 is wired directly to power unit 15 by line 70. Switch 65 is often mounted on a wall adjacent to a service door to the garage. Normally, when the button on switch 65 is pressed, power unit 15 drives door 40 to an open position if door 40 closed, and to a closed position if open. Electrical power to operate in this manner is drawn from line cord 60 which is typically plugged into a nearby outlet mounted in the ceiling of the garage.

In addition to switch 65, power unit 15 can be operated by using remote control 85. Control 85 includes a wireless transmitter that broadcasts a signal to power unit 15 by radio link 80. In the figure, antenna 75 is mounted on power unit 15, however, an antenna may, instead, be located on switch 65. Control 85 is most often used by a driver from within an automobile. Control 85, like switch 65, causes power unit 15 to drive door 40 to an open position if closed, and to a closed position if door 40 is open.

For the reasons stated above, and for other reasons stated below which will become apparent to those skilled in the art upon reading and understanding the present specification, there is a need in the art for systems and methods to control and manage a door opener system or other device using a controller having an unlimited geographical range, interoperability with other systems, simple programming to enable easy set-up and configuration of the remote control system, and feedback indicating status or mode of operation of the opener or other device.

### SUMMARY OF THE INVENTION

The above mentioned problems with door openers and other problems are addressed by the present invention and which will be understood by reading and studying the following specification. A system and method is described which allows remote control and management of single or multiple door openers using a wired or wireless communication device. The device may be a cellular telephone, a pager, a personal digital assistant, a computer or other device that communicates using a network.

In particular, an illustrative embodiment of the present invention includes a processor executing programming and coupled to a door opener, a position sensor, and a wireless transceiver that communicates using both a long range communication protocol and a short range communication protocol. A user need not specify the communication protocol to be used in controlling or managing the opener. The opener receives commands and transmits status information using either or both of the long range and short range protocols. In one embodiment, the system detects the presence of a short range protocol device, disables long range communications, and engages in short range communications with the detected device. When the distance between the device and the door opener exceeds the effective range of the short range device, the system terminates short range communications and establishes a communication link using a long range communication protocol. The communication link, whether long range or short range, provides a channel for communicating information from the door opener to the device and for communicating instructions from the device to the door opener.

Position information is transmitted to the device by a transceiver coupled to the processor. Other information, such as temperature or light levels, may also be transmitted to the device.

### BRIEF DESCRIPTION OF THE DRAWINGS

FIG. 1 schematically illustrates a residential garage door opener.

FIG. 2 illustrates a block diagram of one embodiment of the present system.

FIG. 3 illustrates one embodiment of a transceiver in accordance with one embodiment of the present system.

FIG. 4 illustrates one embodiment of a transceiver in accordance with one embodiment of the present system.

FIG. 5 illustrates one embodiment of a power supply in accordance with one embodiment of the present system.

FIG. 6 illustrates one embodiment of a processor in accordance with one embodiment of the present system.

FIG. 7 illustrates one embodiment of programming in accordance with one embodiment of the present system.

FIG. 8 illustrates one embodiment of a method in accordance with one embodiment of the present system.

### DETAILED DESCRIPTION OF THE INVENTION

In the following detailed description of the preferred embodiments, reference is made to the accompanying drawings which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

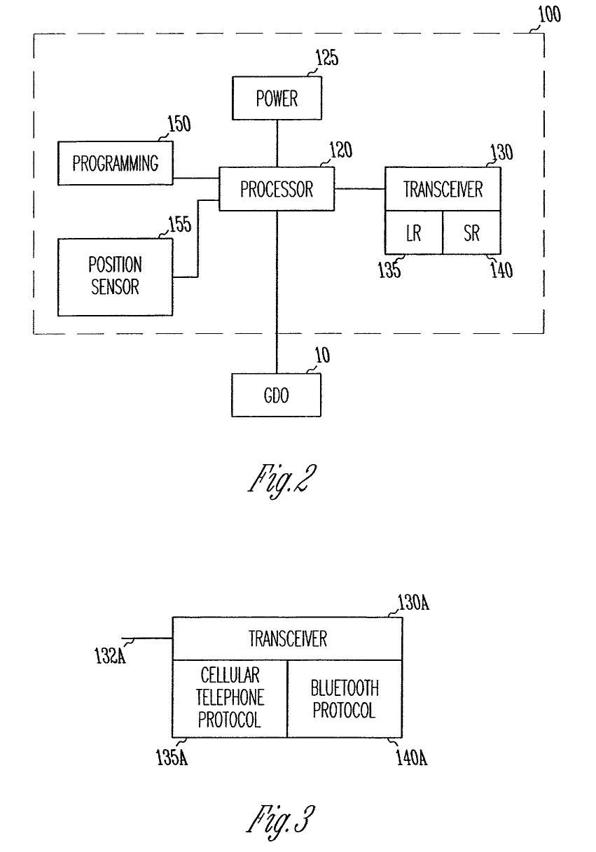

FIG. 2 illustrates a block diagram of one embodiment of present system 100. System 100, illustrated by the dashed box, includes processor 120, power supply 125, transceiver 130, programming 150 and position sensor 155. Processor 120 is coupled to, and executes, programming 150. Processor 120 is also coupled to elements labeled power 125 and transceiver 130.

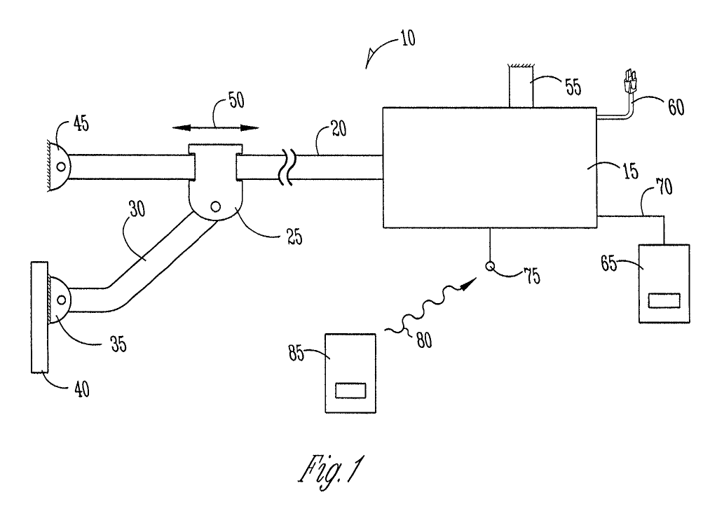

In the figure, GDO 10 represents a garage door opener which may include system 10 as previously described relative to FIG. 1. It will be appreciated that, for purposes of this description, the garage door opener 10 is not included in the system. However, other embodiments of the system are also contemplated, one of which includes the garage door opener as part of the system.

Processor 120 may include a microprocessor as well as memory to perform the programmed functions and to retain settings and configuration information. Processor 120 may also include a driver circuit to provide an electrical signal at a level sufficient to operate the garage door opener. Processor 120 may also include a circuit to receive electrical signals from electrical, or electromechanical sensors and monitors and to provide an electrical signal to drive an actuator.

Power supply 125 represents a power supply system that provides electrical energy for system 100. As described in a subsequent section, power supply 125 may include a battery power supply and a line powered supply.

Programming 150 may include the instructions and data to enable the processor to perform the functions of the present system. Among the programming functions in one embodiment are instructions for causing processor 120 to actuate a particular control upon receiving a predetermined signal. For example, if a garage door position sensor indicates that the door is in a raised position and an obstruction in the path of the garage door travel is detected by an optical sensor, then a signal received by the processor requesting the door to be closed is met with programming requesting that the obstruction be cleared before the door will travel. Processor 120 and programming 150 may include logic gates, circuitry or software to accomplish the selected functions.

Transceiver 130 represents a wireless receiver and transmitter able to communicate using both a long range communication protocol and a short range communication protocol. For example, in one embodiment, the transceiver module includes two separate transceivers, namely, a long range transceiver 135 for long range communications, such as that used with cellular telephone communications and second transceiver for communicating over a short range. A short range communication protocol, such as BLUETOOTH®, allows wireless communications over distances commonly thought of as premises-based. It will be further appreciated that with suitable repeaters, gateways, switches or networks, the effective range of communication of transceiver 130 may be extended to any distance.

In one embodiment, transceiver 130 communicates, using a short range protocol, with a second transceiver that communicates using a long range protocol. For example, transceiver 130 may include a BLUETOOTH® transceiver and may communicate with a second transceiver. The second transceiver, in addition to having a BLUETOOTH® section, also interfaces with a long range communication network. For example, the second transceiver may include a BLUETOOTH® transceiver and a connector that interfaces with a public switched telephone network (PSTN), a cellular telephone network, a pager network or other network having a long range communication protocol.

According to one definition, and subject to the vagaries of radio design and environmental factors, short range may refer to systems designed primarily for use in and around a premises and thus, the range generally is below a mile. Short range communications may also be construed as point-to-point communications, examples of which include those compatible with protocols such as BLUETOOTH®, HomeRF™, and the IEEE 802.11 WAN standard (described subsequently). Long range, thus, may be construed as networked communications with a range in excess of short range communications. Examples of long range communication may include, Aeris MicroBurst cellular communication system, and various networked pager, cellular telephone or, in some cases, radio frequency communication systems.

In various embodiments, a user may communicate with system 100 using a telephone coupled to the public switched telephone network (PSTN), a cellular telephone, a pager (either one way or two way), a personal communication device (such as a personal digital assistant, PDA), a computer, or other wired or wireless communication device.

Position sensor 155 is coupled to processor 120. In various embodiments, sensor 155 may include one or more magnetic switches, contact switches, optical devices or cameras. For example, in one embodiment, sensor 155 includes a first magnetic switch to detect door 40 in an open position and second magnetic switch to detect door 40 in a closed position. Sensor 155 may be connected to processor 120 by a wired connector or by a wireless link. Sensor 155 provides an electrical signal corresponding to the position of door 40. The input to sensor 155 may be derived from door 40, trolley 25, or other member that provides reliable information relative to the position of door 40.

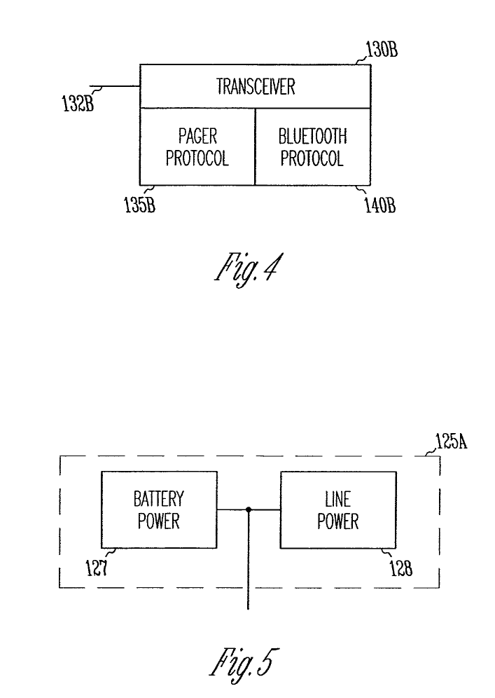

An embodiment of transceiver 130 is illustrated in FIG. 3. Transceiver 130A is coupled to processor 130 by link 132A. In the figure, transceiver 130A is shown having compatibility with both a cellular telephone protocol 135A and a BLUETOOTH® protocol 140A. Other long range communication protocols may include, but are not limited to, cellular telephone protocols, one way or two-way pager protocols, and personal communication service (PCS) protocols. Examples include Time Division Multiple Access (TDMA), 3G, Aloha, Global System for Mobile Communications (GSM), Code-Division Multiple Access (CDMA), Short Message Service (SMS) and General Packet Radio Service (GPRS).

Personal Communications Service (PCS) describes a set of cellular technologies employing CDMA (also known as IS-95), GSM, or North American TDMA (also known as IS-136) air interfaces. PCS systems typically operate in the 1900 MHZ frequency range.

Time Division Multiple Access (TDMA) describes a digital wireless technology using time-division multiplexing (TDM) in which a radio frequency is time divided and slots are allocated to multiple calls. TDMA is used by the GSM digital cellular system.

A third specification, known as 3G, promulgated by the ITU (International Telecommunication Union, headquarters in Geneva, Switzerland) represents a third generation of mobile communications technology with analog and digital PCS representing first and second generations. 3G is operative over wireless air interfaces such as GSM, TDMA, and CDMA. The new EDGE (Enhanced Data rates for Global Evolution) air interface has been developed specifically to meet the bandwidth needs of 3G.

Another protocol, known as Aloha, enables satellite and terrestrial radio transmissions.

Global System for Mobile Communications, GSM, is another digital cellular system and uses TDMA, thus allowing eight simultaneous calls on the same radio frequency.

Code-Division Multiple Access (CDMA) is a digital cellular technology that uses spread-spectrum techniques. CDMA does not assign a specific frequency to each user but rather every channel uses the full available spectrum and individual conversations are encoded with a pseudo-random digital sequence.

Another transmission protocol, Short Message Service (SMS) allows Ace communications of short messages with a cellular telephone, fax machine and an IP address. Messages are generally limited to a length of 160 alpha-numeric characters.

General Packet Radio Service (GPRS) is another standard used for wireless communications and operates at transmission speeds far greater than GSM. GPRS can be used for communicating either small bursts of data, such as e-mail and Web browsing, or large volumes of data.

The short range communication protocol may include, but is not limited to, wireless protocols such as BLUETOOTH®, HomeRF™, wireless LAN (WLAN) or other personal wireless networking technology.

BLUETOOTH® is a trademark registered by Telefonaktiebolaget LM Ericsson of Stockholm, Sweden and refers to short range communication technology developed by an industry consortium known as the BLUETOOTH® Special Interest Group. BLUETOOTH® operates at a frequency of approximately 2.45 GHZ, utilizes a frequency hopping (on a plurality of frequencies) spread spectrum scheme, and provides a digital data transfer rate of approximately 1 Mb/second. In one embodiment, the present system includes a transceiver in compliance with BLUETOOTH® technical specification version 1.0, herein incorporated by reference. In one embodiment, the present system includes a transceiver in compliance with standards established, or anticipated to be established, by the Institute of Electrical and Electronics Engineers, Inc., (IEEE). The IEEE 802.15 WPAN standard is anticipated to include the technology developed by the BLUETOOTH® Special Interest Group. WPAN refers to Wireless Personal Area Networks. The IEEE 802.15 WPAN standard is expected to define a standard for wireless communications within a personal operating space (POS) which encircles a person. In one embodiment, the transceiver is a wireless, bidirectional, transceiver suitable for short range, omnidirectional communication that allows ad hoc networking of multiple transceivers for purposes of extending the effective range of communication. Ad hoc networking refers to the ability of one transceiver to automatically detect and establish a digital communication link with another transceiver. The resulting network, known as a piconet, enables each transceiver to exchange digital data with the other transceiver. According to one embodiment, BLUETOOTH® involves a wireless transceiver transmitting a digital signal and periodically monitoring a radio frequency for an incoming digital message encoded in a network protocol. The transceiver communicates digital data in the network protocol upon receiving an incoming digital message.

In general, the effective communication range of BLUETOOTH® is relatively short, sometimes characterized with a maximum range of approximately 10 to 100 meters. The short range capabilities of BLUETOOTH® are suitable for premises-based applications, such as data exchange within a range roughly equal to the lineal boundaries of a typical property, or premises.

Communication range can be extended beyond this range by a number of different methods. For example, the range may be extended by coupling a BLUETOOTH® connection with a cellular telephone network, a narrow band personal communication systems (“PCS”) network, a CELLEMETRY network, a narrow band trunk radio network or other type of wireless communication link. Examples of PCS technology includes Code-Division Multiple Access (CDMA by Qualcomm Inc.), ReFLEX (by Motorola), Time Division Multiple Access (TDMA), Global Systems for Mobile communications (GSM) or others.

A user with a cellular telephone, or other cellular device, is then able to communicate with the BLUETOOTH® device as though the user was local. The long distance network may include communications using a control channel. One such example is CELLEMETRY®. CELLEMETRY® is a registered trademark of Cellemetry LLC of Atlanta, Ga., USA, and enables digital communications over a cellular telephone control channel. Other examples of communication technology are also contemplated, including MicroBurst™ technology (MicroBurst™ is a trademark of Aeris.net, Inc.) or short message service (SMS). In one embodiment, the long distance network may include a pager network. In one embodiment, the pager network is a two-way pager network enabling bidirectional communication between a BLUETOOTH®-enabled sensor, or device, and a user controlled pager. In one embodiment, the long distance network includes a narrow band Personal Communication System network. In one embodiment, the long distance network may include a telephone network. The telephone network may include communicating using an intranet or the Internet. Coupling to such a network may be accomplished, for example, using a variety of connections, including a leased line connection, such as a T-1, an ISDN, a DSL line, or other high speed broadband connection, or it may entail a dial-up connection using a modem. In one embodiment, the long distance network may include a radio frequency or satellite communication network. In addition, one or more of the aforementioned networks may be combined to achieve desired results.

Another short range communication protocol, known as HomeRF™, currently defined by specification 2.1, provides support for broadband wireless digital communications at a frequency of approximately 2.45 GHZ. HomeRF™ specification 2.1 is herein incorporated by reference.

Other long range and short range communication protocols are also contemplated and the foregoing examples are not to be construed as limitations but merely as examples.

Transceiver 130 may be compatible with more than two communication protocols. For example, transceiver 130 may be compatible with three protocols, such as a cellular telephone communication protocol, a two-way pager communication protocol, and BLUETOOTH® protocol. In such a case, a particular garage door opener may be operable using a cellular telephone, a two-way pager, or a device compatible with BLUETOOTH®. Furthermore, it will be appreciated that each of the aforementioned devices, namely a cellular telephone, a two-way pager, and a device compatible with BLUETOOTH®, may be combined in a single portable housing.

Transceiver 130 may include circuitry to allow communications on more than one protocol. For example, position information may be received on a pager protocol and a user may transmit a command to operate the door opener using a cellular telephone protocol.

FIG. 4 illustrates an embodiment of transceiver 130B that is compatible with a pager protocol 135B and a BLUETOOTH® protocol 140B. Transceiver 130B is coupled to processor 130 by link 132B. Pager protocol 135B may include one way or two way pager protocols. Examples of one way pager protocols include Post Office Code Standardisation Advisory Group (POCSAG), Swedish Format (MBS), the Radio Data System (RDS, by Swedish Telecommunications Administration) format and the European Radio Message System (ERMES, by European Telecommunications Standards Institute) format, Golay Format (by Motorola), NEC-D3 Format (by NEC America), Mark IV/V/VI Formats (Multitone Electronics), Hexadecimal Sequential Code (HSC), FLEX™ (Motorola) format, Advanced Paging Operations Code (APOC, by Philips Paging) and others. Examples of two way pager protocols include ReFLEX™ (Motorola) format, InFLEXion™ (Motorola) format, NexNet™ (Nexus Telecommunications Ltd. of Israel) format and others.

In one embodiment using a pager system, system 100 provides a pager signal to indicate the position of the door or any other information relative to the garage or the door opener. Using a one way pager, the user may operate the door opener, or operate an actuator, using another communication channel, including for example, a cellular telephone or a personal communication device. Using a two way pager, the user may operate the door opener, or operate an actuator, using the reply communication channel of the pager. The outbound signal (e.g., indicating the door position) may be transmitted to the pager on a predetermined schedule, or upon inquiry, or upon a change of position of the door (or actuator) at any time.

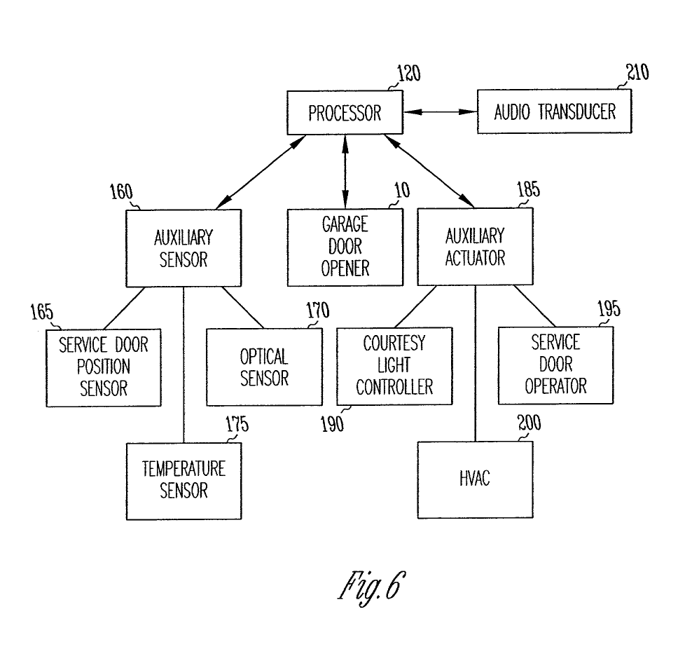

FIG. 5 illustrates one embodiment of power supply 125A. Battery power 127 may include a dry cell, a gel cell, or other power supply. In addition, battery power 127 may include rechargeable batteries. The recharging power may be supplied by line power 128, solar power derived from sunlight, or other available means. Line power 128 may include 110 volt metered electric service, 220 volt metered electric service, or other convenient electrical service. In one embodiment, door opener 10 includes a plug-in power cord which couples to a nearby electrical outlet. In such a case, the battery power 127 is received from line power 128.

In the event of a power outage, or other interruption of the metered electric service, door opener 10 may not be operable. However, battery power 127 has sufficient capacity to continue powering processor 120, transceiver 130, and position sensor 155. Battery power 127 allows the user to continue to wirelessly receive information regarding the position of the door regardless of the status of line power 128. In one embodiment, transceiver 130 provides a wireless signal to the user to indicate that line power 128 has been restored.

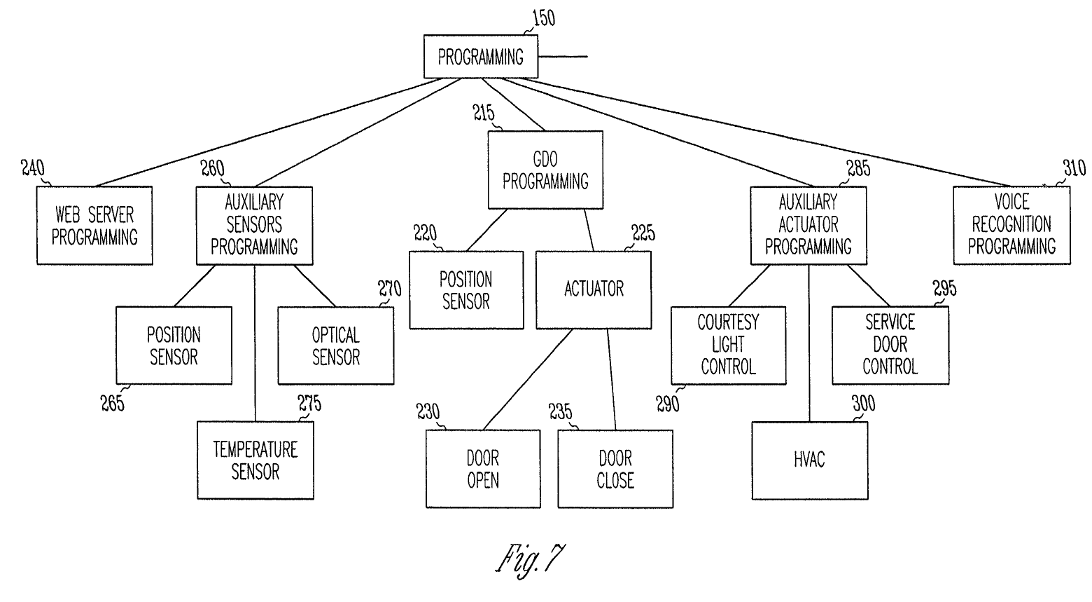

FIG. 6 illustrates a variety of sensors, actuators, and transducers coupled to processor 120. Driver circuits and receiver circuits may be employed between the sensors, actuators, and transducers to provide a signal level compatible with that of the processor. In various embodiments, one or more of the following sensors, actuators, and transducers may be included in system 10. In one embodiment, system 100 includes apparatus to provide a camera view of the door. The camera view may be derived from a video camera or still camera as part of system 100 and the view may represent fall motion video or still photos of the door or other operated equipment.

Auxiliary sensor 160 may be coupled to processor 120. Sensor 165 represents an example of an auxiliary sensor coupled to a service door or other entry. The service door may provide access to the interior of the garage or it may provide access to other areas associated with the garage. For example, sensor 165 may monitor the position of a gate at the driveway to the garage. Optical sensor 170 may include any sensor relying on optical information to generate an electrical signal. For example, sensor 170 may include a light source and photocell to detect hazards associated with operation of door 40 or sensor 170 may provide a signal to indicate if an interior or exterior garage light is illuminated. Sensor 170 may also provide a signal to indicate if it is daytime or nighttime. Temperature sensor 175 may include a thermal element to indicate a temperature present inside the garage or external to the garage. For example, sensor 175 may indicate a freezing hazard or an overheating condition within the garage. Temperature sensor 175 may also be coupled to door opener 10 to indicate a dangerous overheating condition of opener 10.

Door opener 10 may be coupled to processor 120. Door opener 10 may include a system as described above relative to FIG. 1.

Auxiliary sensor 185 may be coupled to processor 120 and may include electrical or mechanical actuators or controls other than opener 10. For example, sensor 190 indicates a courtesy light controller. Using the remote control of the present system, a user can control an interior or exterior courtesy light. Controlling the light may include adjusting the brightness or turning it on, off or flashing the light. As another example, HVAC actuator 200 represents any or all elements of a heating, ventilation and air conditioning system. In particular, HVAC actuator 200 may include a coupling to a mechanical actuator, thermostat, ventilation system or other control. Using the remote control of the present system, a user can control heating, ventilation, or air conditioning system. Sensor 175 may operate in conjunction with HVAC actuator 200. Service door operator 195 indicates a power door actuator coupled to a service door, or other entry, providing access to the interior of the garage or other space.

Audio transducer 210 may be coupled to processor 120 and may include a microphone, speaker, or other audio transducer. The microphone is mounted in a position to receive local audio from a caller located outside of the garage. In one embodiment, audio transducer 210 includes a microphone mounted on the external surface of the structure (or garage) having door opener 10. Alternatively, the transducer is mounted in the interior of the garage and an orifice is provided in the garage wall to pick up sounds external to the garage. Transducer 210, in conjunction with processor 120, provides a voice recognition system that enables voice control of operation of door opener 10, or other actuators.

FIG. 7 graphically presents a block diagram of the functions performed by the programming executing on processor 120. Programming 150 includes, in various embodiments, web server programming 240, auxiliary sensors programming 260, door opener programming 215, auxiliary actuator programming 285 and voice recognition programming 310. Programming may include circuitry, logical gates, software, or other elements.

Web server programming 240 provides an interface to allow remote control of system 100. For example, and not by way of limitation, server programming 240 may include a wireless application protocol (WAP) server that couples to a telephone (or other communication) network to allow a user to operate, program and monitor system 100. In one embodiment, a WAP server generates data that can be accessed using an Internet browser. In such a case, for example, the user can remotely configure system 100 to turn off heater (part of HVAC system 200) anytime door 40 is open and the exterior temperature (as determined by temperature sensor 175) is below 50 degrees Fahrenheit. As another example, the user can remotely configure system 100 to block operation of door opener 10 in response to voice commands (received by audio transducer 210) from a selected person. Data for the user-selected programming may be stored in memory coupled to processor 120. These and other programming configurations are contemplated.

Auxiliary sensors programming 260 may include position sensor programming 265, temperature sensor programming 275, and optical sensor programming 270. Position sensor programming 265 may include software routines and modules that receive and interpret position information derived from door position sensor 165. Optical sensor programming 270 may include software routines and modules that receive and interpret information from optical sensor 170. Temperature sensor programming may include software routines and modules that receive and interpret information from temperature sensor 175. Other sensors, and appropriate programming, are also contemplated.

Door programming may include position sensor programming 220 and actuator programming 225. Position sensor programming 220 may include software routines and modules that receive and interpret position information derived from a door position sensor as part of door opener 10. Actuator programming may include door open programming 230 and door close programming 235. Door open programming 230 may include software routines and modules that raise door 40 in response to commands received by processor 120. Door close programming 235 may include software routines and modules that lowers door 40 in response to commands received by processor 120. Both door open programming 230 and door close programming 235 may also include programming that executes instructions in accordance with user specified, or predetermined, configurations. Door close programming 235 may also check for obstructions in operating the door before instructing door opener 10 to move to a closed position.

Auxiliary actuator programming may include, for example, courtesy light control programming 290, HVAC programming 300 and service door control programming 295. Courtesy light control programming 290 may include software routines and modules that control the operation of an interior, or exterior, courtesy light associated with the garage and coupled to processor 120 by courtesy light controller 190. HVAC programming 300 may include software routines and modules that control the operation of HVAC system 200 coupled to processor 120. Service door control programming 295 may include software routines and modules that control the operation of service door operator 195 coupled to processor 120.

Programming also may include voice recognition programming 310. Voice recognition programming 310 may include software programming for recognizing and executing instructions commensurate with a voice recognition system. The voice recognition system allows a user to speak into audio transducer 210 and gain control over the operation of system 100. Programming 310 may include a security function to authenticate a voice command received by audio transducer 210 before executing any instructions to operate door opener 10.

Other programming functions are also contemplated. For example, a predetermined default setting can be configured to control the operation of system 100 in the absence of a user specified configuration. The user may specify a desired configuration by providing instructions through audio transducer 210, transceiver 130, or a remote link using web server programming 240.

Programming 150 may also include software routines or modules to address prioritization matters. With multiple devices configured to independently control the operation of a single door opener, a problem may arise if conflicting commands are simultaneously received by the system. For example, a conflict arises if a first user transmits a long range communication to open the garage door and at the same time (or shortly thereafter) a second user transmits a short range communication to close the same door. A conflict may also arise if a first user attempts to operate a door using a wired button while a second user attempts to operate the same door using a transmitter compatible with a short range protocol of the present system 100. In such cases, programming 150 executing on processor 120 will execute a routine to determine priority of each received command and suppress lower priority commands. For example, in one embodiment, the long range protocol may be configured to be inferior to that of short range protocol and, in turn, the short range protocol may be inferior to directly wired switch coupled to opener 10. Other priority configurations may also be established. For example, prioritization may be determined on the basis of proximity to opener 10, on the basis of identity of a transmitter, on the basis of signal strength received by transceiver 130, on the basis of recency of last communication, or on any other basis. In one embodiment, the user is empowered to establish a desired configuration. A default configuration may also be provided which is operable in the event that a user-defined configuration is not operable.

Programming 150 may include instructions to cause processor 120 to transmit position information, or any other information, using all modes of communication. In one embodiment, the user is afforded an opportunity to specify the distribution of position information. For example, the user may specify that position information is to be transmitted using only a long range communication protocol during specified hours and to a particularly specified user or group of users.

Programming 150 may also enable processor 120 to communicate with a building security system or control system. For example, in the event of a particular detected security event, door opener 10 may be instructed to either close or open.

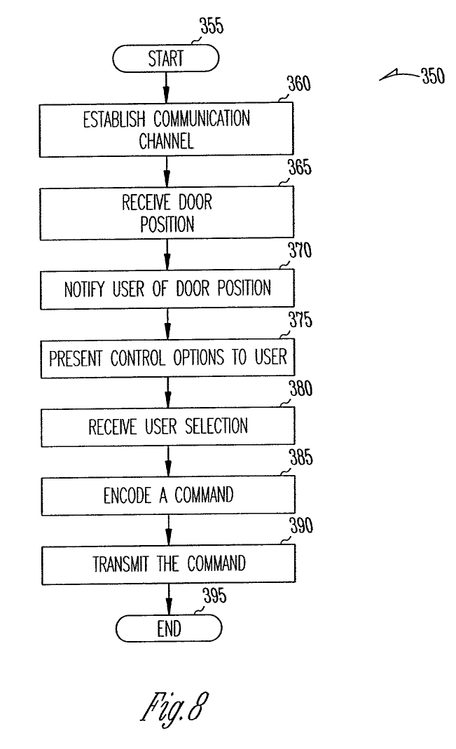

FIG. 8 includes a flow chart describing method 350 involving one embodiment of the present system. Method 350 describes operation of system 100 for receiving door position information and for controlling the door from a remote location.

The method starts at item 355 and assumes that the user has a wireless device capable of communicating with transceiver 130. At 360, the user and system 100 establish a link on a communication channel. At 365, door position information is received by the user. In one embodiment, sensor 155 provides the position information to processor 120. At 370, the user receives notification of the door position information. The door position may be indicated by a pair of lights on a pager (one light labeled “open” and another “close”), by a graphical image on a screen, a recognizable audio tone, a recognizable vibration, or any other means of indicating position to a user. At 375, the user is presented with one or more options to control system 100. In the case that door 40 is open, options may include partially, or fully, closing the door. A single option may be presented that allows the user to toggle the position of the door between a closed and an open position. The option may be a button or several buttons. At 380, the user indicates a selection using the portable wireless device. At 385, the wireless device encodes a message for transmission to system 100 including instructions to operate the door according to the user selection. At 390, the message is transmitted to system 100. The message may be routed to system 100 on wired or wireless communication networks. The method ends at 395.

Other Embodiments

In one embodiment, system 100 is coupled to multiple door openers 10. For example, many homes include two or more garages, each having an individual door opener. Also, commercial applications often include multiple overhead doors, each having an individual door opener. In such cases, multiple door openers 10 may be coupled to a single system 100 which controls and reports the operation of each door opener.

In one embodiment, programming 150 allows a user having a cellular telephone in communication with system 100 to control and monitor each of several door openers 10, or other systems coupled to processor 120. In one embodiment, programming 150 allows a user to control and monitor a single door opener 10, or other system coupled to processor 120. Identification and group membership routines implemented by processor 120 and programming 150 allow for a superior user to configure the authority of multiple inferior users over multiple door openers 10, each coupled to processor 120, using system 100.

The present system has been described, in part, relative to the operation of a garage door opener. However, it will be noted that other doors may be controlled and operated using a suitable power opener. The actuator for many garage door openers is electrically operated, however, it is understood that an actuator operable with the present system may include a pneumatically or hydraulically operated actuator. Furthermore, it will be appreciated that, in addition to operating a door, the present system and method may be adapted for use with other controls, such as a window control, Venetian blind control, skylight control, or other operable device or actuator. By way of example, the present system and method may be adapted to operate with a pet access door, a house entry door, an interior swing door, a patio sliding door, a pocket door, an apartment entry door, a sliding window, or an elevator or lift access door. For instance, the present system may be adapted for use with a handicap access door.

In one embodiment, system 100 includes circuitry and programming to detect proximity of a compatible transceiver. For example, system 100 may include a BLUETOOTH® compatible transceiver which implements a self-aware feature to determine the presence of a compatible device within effective range. Thus, if system 100 detects that a compatible device is within range, then a preprogrammed function is executed. Security systems or authorization systems are included in system 100 to ensure that any detected compatible device is authorized to exercise control over system 100. For instance, and in one embodiment, if a BLUETOOTH® equipped wireless garage door opener is brought within a predetermined range, then system 100 automatically operates an electric garage door opener. In particular, if the door is closed at a time when the door opener is brought within range, then system 100 operates to open the door and if the door is open at a time when the door opener is brought within range, then system 100 operates to close the door. As another example, one embodiment of the present system 100 includes a BLUETOOTH® equipped wireless pet collar and a BLUETOOTH® equipped pet door opener. The pet door is thus automatically opened when a dog wearing the collar approaches the door. As yet another example, one embodiment of the present system 100 includes a BLUETOOTH® equipped module and a BLUETOOTH® equipped handicapped-person accessible door opener. The handicapped-person accessible door is thus automatically opened when a person carrying the module approaches the door. The module may be affixed to a wheelchair or other device.

### Conclusion

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention.

What is claimed is:

1. A device comprising:
a processor adapted for coupling to a door opener and having programming including instructions for generating a command to operate the door opener;
a first position sensor coupled to the processor and adapted for generating a first position signal based on a position of a first door coupled to the door opener;
a radio frequency transceiver coupled to the processor and adapted for transmitting the first position signal using a long range communication protocol and a short range communication protocol, and for receiving a wireless signal using the long range communication protocol and the short range communication protocol, the transceiver including circuitry for spread spectrum frequency hopping and wherein the command is based on the wireless signal.

2. The device of claim 1 wherein the transceiver is adapted for communicating on a protocol compatible with a cellular telephone communication protocol.

3. The device of claim 1 wherein the transceiver is adapted for communicating on a protocol compatible with a pager communication protocol.

4. The device of claim 1 wherein the transceiver operates at a frequency of approximately 2.45 GHZ.

5. The device of claim 1 wherein the transceiver is substantially compatible with standards under IEEE 802.15.

6. The device of claim 1 wherein the transceiver is substantially compatible with BLUETOOTH® technical specification version 1.0.

7. The device of claim 1 wherein the first position sensor includes a magnetic switch.

8. The device of claim 1 wherein the first position sensor includes a contact switch.

9. The device of claim 1 wherein the first position sensor includes a camera.

10. The device of claim 1 further comprising a battery coupled to the processor and coupled to the transceiver.

11. The device of claim 1 further comprising an optical sensor coupled to the processor and adapted for generating a light level signal based on light intensity in a region proximate to the first door, and further wherein the transceiver is adapted for transmitting the light level signal.

12. The device of claim 1 further comprising a second position sensor coupled to the processor and adapted for generating a second position signal based on a position of a second door, and farther wherein the transceiver is adapted for transmitting the second position signal.

13. The device of claim 1 wherein the processor includes programming having instructions for generating a web page accessible from the Internet.

14. The device of claim 1 further comprising an audio transducer coupled to the processor and further wherein the processor includes programming having instructions for operating the door opener in response to a vocal command received by the transducer.

15. A method of manufacturing a module comprising:
adapting a processor to couple with a door opener;
adapting the processor to couple with a first position sensor;
coupling a wireless transceiver adapted for spread spectrum frequency hopping to the processor;
adapting the transceiver to receive a first signal in a protocol compatible with a long range communication protocol and in a protocol compatible with a short range communication protocol;
adapting the transceiver to transmit information received from the first position sensor in a protocol compatible with a long range communication protocol and in a protocol compatible with a short range communication protocol; and
providing a program for executing on the processor, the program having instructions to cause the processor to operate the door opener based on the first signal.

16. The method of claim 15 wherein adapting the transceiver to receive a first signal in a protocol compatible with a long range communication protocol includes adapting the transceiver to receive the first signal in a protocol compatible with a long range cellular telephone communication protocol.

17. The method of claim 15 wherein adapting the transceiver to receive a first signal in a protocol compatible with a long range communication protocol includes adapting the transceiver to receive the first signal in a protocol compatible with a pager communication protocol.

18. The method of claim 15 further comprising providing a battery connector coupled to the processor and to the transceiver.

19. The method of claim 15 further comprising adapting the processor to couple with a second position sensor and wherein the transceiver is adapted for transmitting information received from the second position sensor.

20. The method of claim 15 further comprising adapting the processor to couple with an optical sensor and wherein the transceiver is adapted for transmitting a light level signal based on light intensity in a region proximate to a door coupled to the door opener.

21. The method of claim 15 further comprising adapting the processor to generate a command to open a door coupled to the door opener in response to an open signal received by the transceiver in a protocol compatible with the long range communication protocol.

22. The method of claim 15 further comprising adapting the processor to generate a command to open a door coupled to the door opener in response to an open signal received by the transceiver in a protocol compatible with the short range communication protocol.

23. The method of claim 15 further comprising adapting the processor to generate a command to close a door coupled to the door opener in response to a close signal received by the transceiver in a protocol compatible with the long range communication protocol.

24. The method of claim 15 further comprising adapting the processor to generate a command to close a door coupled to the door opener in response to a close signal received by the transceiver in a protocol compatible with the short range communication protocol.

25. The method of claim 15 further comprising adapting the processor to generate a web page accessible from the Internet.

26. The method of claim 15 further comprising adapting the processor to couple with an audio transducer and to operate the door opener in response to a vocal command received by the transducer.

27. A method of operating a door comprising:
establishing a wireless communication channel with a module coupled to the door;
transmitting a position signal on the channel based on a position of the door;
providing an indication to a user based on the position signal; and
receiving an instruction signal on the channel, the instruction signal based on a user selected option for operating the door.

28. The method of claim 27 wherein establishing a wireless communication channel with a module coupled to the door includes communicating using a protocol compatible with a cellular telephone.

29. The method of claim 27 wherein establishing a wireless communication channel with a module coupled to the door includes communicating using a protocol compatible with a pager.

30. The method of claim 27 wherein establishing a wireless communication channel with a module coupled to the door includes communicating using a protocol compatible with BLUETOOTH® technical specification version 1.0.

31. The method of claim 27 wherein providing an indication to a user based on the position signal includes providing a visual indication.
